(19) United States
(12) Patent Application Publication
(10) Pub. No.: US 2006/0249889 A1
(43) Pub. Date: Nov. 9, 2006

(54) Production and use of a sacrificial mold core for metal casting

(75) Inventors: Holger Bausinger, Stuttgart (DE); Ralf Lebbing, Warstein (DE); Rolf Pfeifer, Eislingen (DE)

Correspondence Address: AKERMAN SENTERFITT, P.O. BOX 3188, WEST PALM BEACH, FL, 33402-3188, US

(73) Assignee: DaimlerChrysler AG, Stuttgart (DE)

(21) Appl. No.: 11/371,448

(22) Filed: Mar. 9, 2006

(30) Foreign Application Priority Data
Mar. 10, 2005 (DE) 10 2005 011 019.3

(51) Int. Cl. B28B 1/00; B28B 3/00; B28B 5/00; C04B 33/32

(52) U.S. Cl. 264/637; 264/651

(57) ABSTRACT

The manufacture and use of sacrificial molds for metal casting, in particular for sacrificial molds of green ceramic. For production of the ceramic cast mold one frequently resorts to slip-casting in which the shaping of the mold is brought about by casting of liquid slip into the original mold. Bubbles or blisters frequently occur in this casting, which in the later mold lead to not tolerable surface and joint faults of the mold. This can only partially be counteracted by employment of so-called boosting and careful pouring. It is thus the task of the invention to provide a process for production of mold cores of slip ceramic for metal casting, in which the problem of bubbles or blisters is at least reduced. The invention is solved by using a porous original mold. This provides the advantage, that enclosed or trapped air bubbles or blisters can escape through the pores of the original mold, while the slip on the basis of its surface tension cannot penetrate into the pores.

### CROSS REFERENCE TO RELATED APPLICATION

This application claims the benefit of German Application No. DE 10 2005 011 019.3-24 filed Mar. 10, 2005.

### BACKGROUND OF THE INVENTION

### FIELD OF THE INVENTION

The invention concerns the manufacture and use of sacrificial mold cores for metal casting, in particular sacrificial mold cores of green ceramic. Mold cores of this general type are known for example from DE3884613T2.

The production of cast parts with recesses, cutbacks and hollow structures places high demands on the manufacturing methodology and the materials of the corresponding casting molds. In the art of metal casting, as a rule, due to the high temperatures occurring therein, ceramic cast molds are employed.

For production of the ceramic cast mold one frequently resorts to slip-casting in which the shaping of the mold is brought about by casting of liquid slip into the original mold.

Bubbles are frequently formed in this casting liquid, which in the later mold lead to unacceptable surface and joint faults of the mold core. This can only partially be counteracted by employment of so-called boosting and careful pouring.

### SUMMARY OF THE INVENTION

It is thus the task of the invention to provide a process for production of mold cores of slip ceramic for metal casting, in which the problem of bubbles is at least reduced.

With regard to the process for production of a sacrificial mold core for metal casting, the task is inventively solved by the following steps:
providing a porous original mold,
providing a slip, containing ceramic micro-particles,
filling the original mold with the slip,
freezing the slip to form a green mold core,
releasing the green mold core from the original mold,
drying the green mold core,
heating the green mold core until hardening, wherein the porous original mold is produced by means of a rapid prototyping process or of a naturally porous material, for example, zeolite.

The process having the above characteristics provides the advantage, that during casting the air bubbles which had formed or became trapped can escape through the pores, while the slip cannot penetrate into the pores due to its surface tension. This makes it possible to dispense with the conventional enhancers and other air evacuation techniques as well as various casting devices. In the case large and/or complex components the pouring-in can occur at multiple locations in different directions simultaneously—without the danger of enclosing air.

The porosity of the original mold can be produced various ways. For example the mold can be machined from a porous material and namely (above all in the case of simple shapes) one piece or multi-piece, wherein the individual parts can be joined together to make the original mold, preferably by adhering. The porous material can be of natural (for example zeolite) or of artificial origin (for example sinter products).

### DESCRIPTION OF RELATED ART

One advantageous variant of the method of manufacturing of the original mold is provided by the known rapid prototyping process, in particular the powder based processes of 3D printing and selective laser sintering, on the basis of their speed and precision. Also, the rapid process “laminated object manufacturing” allows the manufacture of porous original molds such as disclosed for example in DE10157757A1.

With the rapid process the original mold can likewise be produced as one part or multipart. In the case of a one part original shapes the remaining, not bound powder can be removed by blowing out or washing out. An advantage of the powder-based rapid process is the resulting porosity of the original mold without supplemental measures. Beyond this, original molds with thin walls (1 to 3 mm) can be produced without problem, which becomes advantageous in particular in the later necessary removal of the original mold from the mold. Further, there is no limitation with respect to the selection of materials: metals, ceramics as well as organic materials can be employed.

The necessary removal of the original mold from the mold can be carried out particularly advantageously by chemical dissolving of the original mold. Therein it must be observed that the mold is not likewise attacked by the solvent.

Particularly suited are thus original molds of organic material, in particular plastics, for example polystyrene, which are highly soluble in solvents such as toluene, acetone, ethylmethylketone, 2-butanone or others which do not attack the mold.

It is likewise advantageous when the solvent for the original mold and the liquid component of the slip (generally water) are not miscible, in order to avoid penetration of the solvent into the mold by dispersion. This is most pronounced in the case when using toluene and water.

Preferably the vapors or off-gases are suctioned off during the dissolving of the original mold, since, depending upon the solvent, they can cause unpleasant odors or even be a health hazard.

A further advantageous embodiment of the inventive process is characterized by the application of colloidal nano-particles on the green mold, wherein heating of the mold for hardening is carried out in such a manner, that organic components of the green mold core off-gas and the colloidal nano-particles sinter to form a stable external skin on the mold.

The product of such a process is a mold with a core of micro-particles and an external skin of micro and nano-particles. Micro particles are particles with diameters in the micrometer range, and accordingly nano-particles are particles with diameters in the nanometer range.

In accordance with the invention the filling of the original mold with slip occurs by pouring in, spraying in or dipping—respectively with no pressure or with low pressure. The application of colloidal nano-particles upon the green mold occurs by spraying-on or brushing-on of a dispersion, for example, with a brush. Also conceivable is a dusting or a dipping of the mold in the dispersion.

With regard to the organic components of the green mold core, these are primarily binders as well as small amounts of additives. By their off-gassing during the heating or thermal treatment of the green mold, the micro-particles on the inside of the mold remain in an essentially loose arrangement. The integrity of the mold is attributable primarily to the external skin, which obtains its stability by sinter-bridging of the partially or completely molten nano-particles between the micro-particles. These sinter bridges exhibit sufficient strength in order to allow handling of the mold core subsequent to removal from the original mold as well as to survive the metal casting without damage. Nevertheless, it is weakened as a result of the metallic casting and the thereupon occurring pressure tensions in such a manner that it can be broken up with a water jet and in this manner the mold can be washed out of the cast part.

Besides this, by the limitation of the sintering to the thin external skin, the typical sintering shrinkage is reduced to a minimum, whereby and essentially improved dimensional stability of the molds results.

In an advantageous embodiment of the inventive process micro-particles and/or nano-particles of refractory oxides, carbides or nitrides are employed, in particular of the elements Al, Zr, Si, Mg, Ca, or Ti. Preferably the micro-particles are comprised of zirconium silicate and the nano-particles of silicon dioxide.

This type of material exhibits a sufficient temperature stability, a good workability as well as good commercial availability and prices for suitable particle sizes.

Preferably at least two particle size classes of micro-particles are employed for production of the slip in order to achieve a better volumetric filling.

The slip is preferably prepared with water, in particular with de-ionized water, in order to preclude to the extent possible the influence of additives. This type of additive is for example dispersants, antifoaming agents and anti-freeze agents. The last can be added in order to prevent the formation of large ice crystals during freezing of the slip, which could otherwise lead to microstructure faults in the mold.

In one advantageous embodiment of the inventive process, during heating a maximal temperature of between 750° and 1200° C., preferably 800° C. is reached, wherein the maximal temperature is maintained constant for 30 to 120 minutes, preferably 60 minutes.

With a maximal temperature and duration of this type, a sintering of the nano-particles of the above-mentioned material is achieved, which ensures a sufficient stability of the mold.

In a particularly advantageous embodiment of the inventive process the maximal temperature is achieved by a continuous, preferably linear, temperature rise of between 100° and 150° C./hour, preferably 120° C./hour.

This ensures an even and complete off-gassing of the organic components.

Preferably the off-gasses are vented or vacuumed during heating, since, depending upon their composition, they could cause an unpleasant odor or even present a hazard to health.

In a further advantageous embodiment of the inventive process the application of the nano-particles occurs by spraying or brushing with dispersion of nano-particles, preferably with an aqueous dispersion. This makes possible the formation of a uniform external skin. The aqueous dispersion is advantageous with respect to a safe processing and the subsequent off-gassing.

The task with regard to the use of a sacrificial mold for metal casting is inventively solved by the casting of components for internal combustion engines of steels, light metals or their alloys, in particular the precision casting according to the sacrificial wax process, preferably the aluminum precision casting. Besides this, it is suited for the production of ceramic molds assembled of several parts.

In the following the inventive mold, the process for its manufacture and its use are described in greater detail on the basis of an illustrative embodiment:

First, an original mold for a wheel well or wheel arch mold is provided. This is comprised of 1 to 3 mm thick, porous polystyrene halves adhered to each other, which by means of selective laser sintering are built up from a 3-D data set of the wheel well.

Besides this, a slip is prepared. For production of the slip the components according to Table 1 are weighed in a mixing container and mixed with each other over a period of twelve hours with a drop-roller or pestle. Thereafter successively the micro-particles II are added thereto and again mixed for twelve hours. For improving the mixing process ceramic balls with a diameter of 20 mm are added in.

TABLE 1
Composition of the Slip.

| | Relative Net Weight |
|---|---|
| Component | (Weight Percent) |
| H₂0 deionized | 8.51% |
| Antifreeze (Glycerin 87%) | 1.49% |
| Dispersing Agent (Dolalpix PC33) | 1.08% |
| Anti-foaming Agent (Agitan 280) | 0.01% |
| Micro-particle I | 51.67% |
| Micro-particle II | 37.24% |
| Sum | 100.00% |

The antifreeze serves to prevent the formation of large ice crystals during freezing of the slip.

As dispersing agent, a 25% aqueous solution of a polyelectrolyte is employed, which is available under the trade name Dolapix PC33®.

As micro-particles, zirconium silicate particles of different particle size distributions are employed. The fraction I has an average particle size of approximately 2 μm (trade name: Ultrox Standard), Fraction II of approximately 23 μm (trade name: Zircon 200 mesh).

Shortly prior to the end of the mix time ten drops of anti-foaming agent (combination of liquid hydrocarbons, silicic acid, synthetic copolymers and non-ionic emulsifiers; trade name Agitan 280) are mixed in prior to the end of the mixing time.

The finished slip exhibits a density of 2.7 g/cm³ as well as a water content of 9-10 wt. %. It is stored with stirring.

The prepared slip is evenly poured into the already prepared porous original mold of laser sintered polystyrene powder. Enclosed air bubbles escape through the pores of the original mold. The slip cannot penetrate into the pores due to its surface tension.

Thereafter the slip is frozen into a green mold. For this, the original mold filled with the slip is cooled in a cooling device evenly to −40° C. and left therein for one hour.

Subsequently the removal of the green mold core from the original mold occurs. For this the frozen mold core is introduced into a toluene bath in a cooling device at approximately −20° C. The toluene dissolves the polystyrene of the original mold without damaging the mold core. The dissolving process takes approximately twelve (12) hours. Rising vapors are vacuumed off. Subsequently one allows the mold core to drip approximately another fifteen minutes over the toluene bath.

The still moist green mold is stored for ventilation drying at −20° C., that is, significantly below the freezing point of the ceramic suspension.

For drying, a conventional ventilation oven is provided. First the frozen mold core is dried for one hour at room temperature with use of a dry stream of air. Thereafter the temperature is evenly raised to 50° C. and the drying is carried out for an additional three hours.

Subsequently the temperature is raised to 500° C. evenly over a period of five hours and is maintained therein for an additional hour. Thereafter free cooling to room temperature occurs. This heating serves to off-gas the organic components, which are present in the form of polystyrene residues as well as antifreeze, dispersing agent and antifoam agent. The off-gases resulting therefrom are vacuumed off.

Thereafter the colloidal nano-particles are applied to the green mold core. For this, an aqueous dispersion of silicon dioxide nano-particles (Tradename: Syton® X30, manufacturer DuPont) is thinly brushed on with a brush. The particles have an average size of approximately 40 mm and represent approximately 30 wt. % of the dispersion.

Thereafter the green coated mold is sintered. For this it is heated up at a heating rate of 150° C./hour to a maximum temperature of 800° C. and this maximum temperature is maintained for 60 minutes. Thereafter it is evenly cooled to room temperature.

The nano-particles form sinter bridges between the micro-particles at this temperature-protocol, so that a stable external skin forms on the mold.

The stable mold core is introduced into a casting form and filled with a metallic melt. After casting the cooling metal shrinks on the mold core, whereupon pressure tensions result. These pressure tensions weaken the stability of the external skin sufficiently that it can be broken up with a water jet and thus the external skin and the loose interior of the mold can be easily washed out of the casting.

The inventive mold core and the inventive process for its manufacture demonstrate themselves in the illustrated embodiment of the above-described example as particularly suited for metal casting, in particular for aluminum precision casting, in the automobile industry.

In particular, substantial advantages with regard to the quality of interior surfaces can be achieved thereby.

The invention is not limited to the above-described illustrative example, but rather can be broadly applied.

In place of the polystyrene powder there can be employed, for example, also polyamide (PA) or PMMA powder.

In place of laser sintering of the powder, 3D printing can also be used for production of the original mold.

Thus it is conceivable for example that in place of two size fractions of micro particles of zirconium silicate a single size fraction of Al₂O₃ or SiC micro-particles is employed.

The nano-particles of silicon dioxide can be replaced by those of titanium dioxide, zirconium silicate, aluminum oxide, zirconium oxide, mullite ceramic or combinations thereof.

In place of glycerin as the antifreeze, also gelatin, agar-agar or agarose as well as ethylene glycol could be employed.

1. A process for production of a sacrificial mold for metallic casting with the steps:
providing a porous original mold,
providing a slip containing ceramic micro-particles,
filling the original mold with the slip,
freezing the slip into a green mold core,
releasing the green mold core from the original mold,
drying the green mold core,
heating the green mold core until hardening thereof, wherein the porous original mold is produced by a rapid prototyping process.

2. A process for production of a sacrificial mold for metallic casting with the steps:
providing a porous original mold,
providing a slip containing ceramic micro-particles,
filling the original mold with the slip,
freezing the slip into a green mold core,
releasing the green mold core from the original mold,
drying the green mold core,
heating the green mold core until hardening thereof, wherein the porous original mold is produced from a naturally porous material.

3. A process for producing a mold according to one of the preceding claims, wherein the releasing of the green mold out of the porous original mold occurs by chemical dissolving of the original mold.

4. A process for producing a mold according to claim 1, further comprising:
applying colloidal nano-particles upon the green mold core,
wherein said heating is carried out in such a manner,
that organic components are off-gassed out of the green mold core, and
that the colloidal nano-particles are sintered to form a stable external skin on the mold core.

5. A process for producing a mold according to claim 1, wherein the heating reaches a maximum temperature of between 750° and 1200° C., and wherein the maximum temperature is maintained constant for 30 to 120 minutes.

6. A process for producing a mold core according to claim 5, wherein the maximum temperature is achieved by a continuous temperature increase of between 100° and 150° C./hour.

7. A process for producing a mold core according to claim 1, wherein during heating off-gases are exhausted or vented.

8. A process for producing a mold according to claim 4, wherein the application of the nano-particles occurs by spraying or brushing of a dispersion of the nano-particles.

9. A method for casting components for internal combustion engines of steel or light metal, said method comprising:
producing a sacrificial mold by (a) providing a porous original mold produced by a rapid prototyping process or from a naturally porous material, (b) providing a slip containing ceramic micro-particles, (c) filling the original mold with the slip, (d) freezing the slip into a green mold core, (e) releasing the green mold core from the original mold, (f) drying the green mold core, (g) heating the green mold core until hardening thereof.
casting a steel or light metal into said sacrificial mold to form a cast component for an internal combustion engine, and
breaking up and removing the sacrificial mold from the casting.

10. A method as in claim 9, wherein multiple sacrificial mold cores are joined or assembled to produce a ceramic casting mold.
